(19) United States
(12) Patent Application Publication
(10) Pub. No.: US 2007/0033067 A1
(43) Pub. Date: Feb. 8, 2007

(54) System and method for determining a constant stock policy

(75) Inventor: John M. Bossert, Boston, MA (US)

Correspondence Address: PILLSBURY WINTHROP SHAW PITTMAN, LLP, P.O. BOX 10500, MCLEAN, VA, 22102, US

(73) Assignee: Optiant, Inc., Burlington, MA (US)

(21) Appl. No.: 11/197,506

(22) Filed: Aug. 5, 2005

(51) Int. Cl. G06Q 10/00

(52) U.S. Cl. 705/2

(57) ABSTRACT

A system and method for determining a constant inventory stock policy for stocking a good at a stage within a supply chain. The constant stock policy may be determined so as to enable non-stationary demand to be met by the stage over a planning horizon, even though the constant stock policy remains constant over the planning horizon.

### FIELD OF THE INVENTION

The invention relates to inventory modeling.

### BACKGROUND OF THE INVENTION

Typically, in order for companies to operate efficiently, they attempt to efficiently manage resources available to them. These resources may include labor, equipment, money, land and information. Mathematical models are implemented by some companies to provide enhanced management of these resources.

One example of resource management may include inventory. Inventory control may enable a company to provide a customer with a substantially continuous supply of a product. However, maintaining inventory tends to deplete resources, and may be expensive. Therefore, companies generally try to minimize the amount of inventory on hand by attempting to adopt a stock policy that will reduce inventory to the lowest possible level at which they will still be able to service the received demand.

Since, in many practical situations, the parameters describing demand change over time, or are non-stationary, stocking policies typically adapt with predicted shifts in demand in order to minimize inventory, with the adaptations designed to reduce the surplus inventory on hand. However, several drawbacks exist in implementing a stock policy that fluctuates with time. For example, conventional software for aiding companies in ordering and stocking inventory provides little, or no, support for employing a fluctuating stock policy. Additionally, stock policies that fluctuate with time tend to de-stabilize a supply chain as changes to a stock policy at one stage of a supply chain may be magnified at stages upstream in the chain due to the known phenomenon of “bull-whipping.” Other drawbacks associated with conventional inventory systems also exist.

### SUMMARY

Various aspects of the invention overcome at least some of these and other drawbacks of existing systems.

One aspect of the invention relates to a system and method for determining a constant inventory stock policy for stocking a good at a stage within a supply chain. The constant stock policy may be determined so as to enable non-stationary demand to be met by the stage over a planning horizon while reducing an amount of surplus stock in inventory, even though the constant stock policy remains constant over the planning horizon.

In some embodiments of the invention, the constant stock policy may be determined by determining a target service level that may be related to the probability that the stock in inventory will be sufficient to meet demand over a planning horizon, defining the planning horizon, predicting demand for the good over the planning horizon, and determining the constant stock policy that provides a service level over the planning horizon that is sufficiently close to the target service level, wherein the constant stock policy remains constant over the planning horizon.

In some embodiments of the invention, the planning horizon may be divided into planning intervals. The planning intervals may include time phases that may be determined such that the demand for the good within each of the individual time phases may be substantially stationary. In some instances, the planning intervals may include review periods during which inventory of the good at the stage may be reviewed. The planning intervals may be set to be periodic, or may include planning intervals of various lengths.

According to various embodiments of the invention, the service level provided by the constant stock policy over the planning horizon may be determined by aggregating individual service levels provided by the constant stock policy within the individual planning intervals. The individual service levels provided by the constant stock policy within the individual planning intervals may be aggregated by determining a weighted average of the individual service levels. The individual service levels may be weighted, in order to determine the weighted average, according to the predicted demand for the good within the individual planning intervals.

In some embodiments of the invention, the constant stock policy may include a constant base stock policy that may enable maintenance of a substantially constant base stock. Base stock may include the sum of the inventory on hand plus the inventory on order minus any backorders. In other embodiments, the constant stock policy may include a constant safety stock policy that may enable maintenance of a substantially constant safety stock. Safety stock may include the amount of inventory on hand just before an order arrives.

These and other objects, features, and advantages of the invention will be apparent through the detailed description of the embodiments and the drawings attached hereto. It is also to be understood that both the foregoing general description and the following detailed description are exemplary and not restrictive of the scope of the invention. Numerous other objects, features, and advantages of the invention should now become apparent upon a reading of the following detailed description when taken in conjunction with the accompanying drawings, a brief description of which is included below. Where applicable, same features will be identified with the same reference numbers throughout the various drawings.

### BRIEF DESCRIPTION OF THE DRAWINGS

FIG. 1 is a schematic representation of a supply chain, according to one embodiment of the invention.

FIG. 2 illustrates an order cycle with a deterministic lead time and an order cycle with a stochastic lead time, according to one embodiment of the invention.

FIG. 3 illustrates a graphical representation of demand, according to some embodiments of the invention.

FIG. 4 illustrates a graphical representation of orders placed for goods between stages of a supply chain, in accordance with some embodiments of the invention.

FIG. 5 is an exemplary illustration of a system for determining a constant stock policy, in accordance with some embodiments of the invention.

FIG. 6 is an exemplary flowchart of a method of determining a constant stock policy for a stage in a supply chain, according to some of the embodiments of the invention.

FIG. 7 is an exemplary flowchart of a method of determining a constant stock policy, in accordance with one embodiment of the invention.

### DETAILED DESCRIPTION

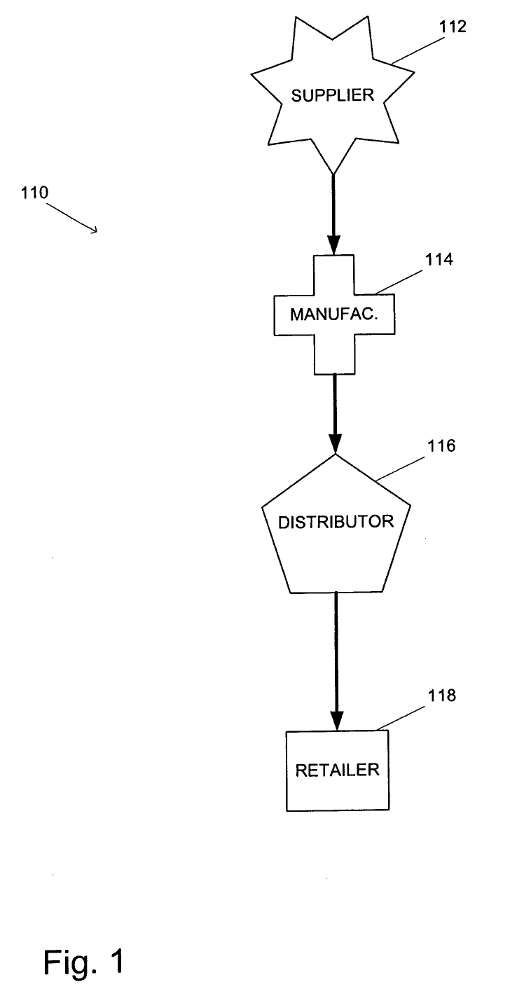

FIG. 1 is a schematic representation of a supply chain 110, according to one embodiment of the invention. Supply chain 110 may include a plurality of stages, such as a supplier stage 112, a manufacturer stage 114, a distributor stage 116, and a retailer stage 118, among other stages. Supplier stage 112 may supply a raw material to manufacturer stage 114, based on orders placed with supplier stage by manufacturer stage 114. Manufacturer stage 114 may manufacture a good using this raw material, and may supply the manufactured good to distributor stage 116, based on orders for the manufactured good from distributor stage 116 to manufacturer stage 114. Distributor stage 116 may warehouse the manufactured good, and may distribute the manufactured good to retailer stage 118, based on orders for the manufactured good placed by retailer stage 118 with distributor stage 116. In turn, retailer stage 118 may sell the good to one or more consumers. Supply chain 110 may be referred to as a multi-echelon system, due to the hierarchical nature of the flow of goods between stages 112, 114, 116, and 118. Although supply chain 110 is illustrated as a serial chain, including a single stage at each echelon, or level, in supply chain 110, it will be appreciated that this is for illustrative purposes only, and that the scope of the invention encompasses systems in which one or more of the echelons may include a plurality of stages and the network is not limited to a certain form (e.g., serial line, distribution network, assembly network, spanning tree, etc.). For example, in one embodiment, distributor stage 116 may distribute a good to a plurality of retailers.

In some embodiments of the invention, the flow of goods along supply chain 110 may ultimately be driven by consumer demand on the manufactured goods at retailer stage 118. More particularly, retailer stage 118 may stock its inventory to meet the consumer demand. This may include placing orders for the manufactured goods from distributor stage 116. To meet the orders, or demand, of retailer stage 118, distributor stage 116 may stock its inventory to an appropriate level by placing orders for the manufactured goods from manufacturer stage 114. Manufacturer stage 114 may stock its inventory to meet the demand for the manufactured good of distributor stage 116. This may include placing orders for the raw materials from supplier stage 112, so that an appropriate amount of the manufactured goods can be manufactured. Finally, supplier stage 112 may stock an inventory of the raw material that is designed to meet the demand for the raw material by manufacturer stage 114. Thus, consumer demand for the manufactured good at retailer stage 118 may be propagated up supply chain 110.

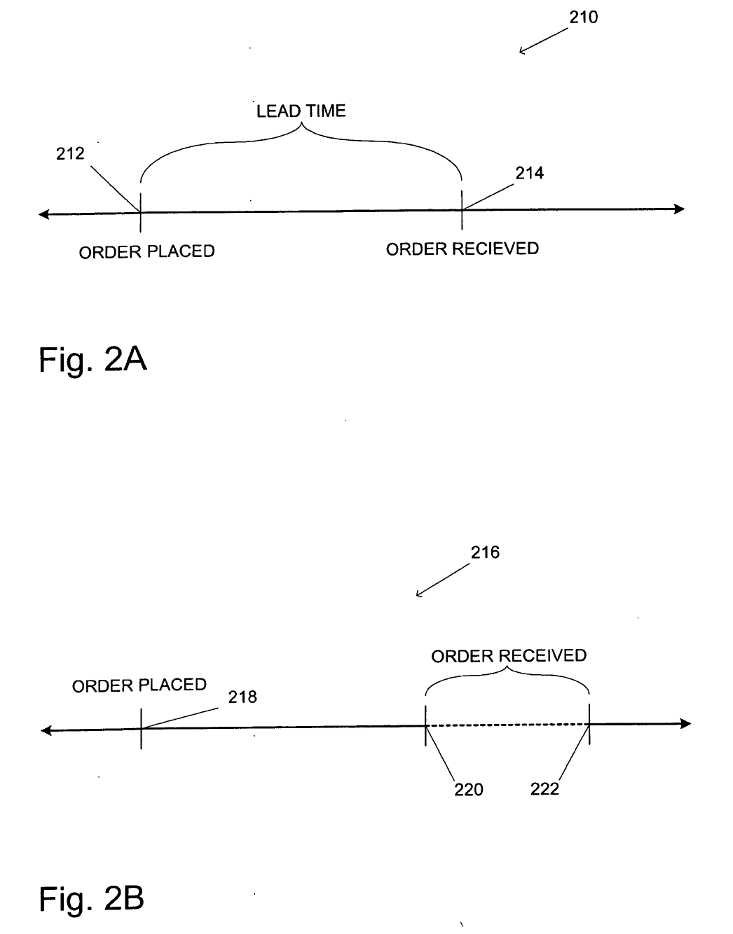

Referring to FIG. 2A, a timeline 210 of an order cycle is illustrated according to one embodiment of the invention. At a point 212 on timeline 210 an order is placed between stages in a supply chain (e.g. supply chain 110). At a point 214 on timeline 210 that occurs after point 212, the order placed at point 212 may be filled. The period between point 212 when the order is placed and point 214 when the order is filled may be referred to as the “lead time.” If the lead time for orders of a good is substantially constant for a particular set of orders (e.g. the set of orders from one stage to another stage in a supply chain), the lead time for orders within the set of orders may be referred to as “deterministic.” In other words, if an order has a deterministic lead time, then when the order is placed, the arrival of the order may be predicted with relative certainty.

Turning to FIG. 2B, a timeline 216 illustrating a lead time of an order, according to another embodiment of the invention, is shown. In FIG. 2B, an order is placed at a point 218 on timeline 216. However, the arrival of the order may not be predicted with the same degree of certainty as the order shown in FIG. 2A. In FIG. 2B, the arrival of an order placed at point 218 may only be predicted to fall within a window of time between a point 220 on timeline 216 and a point 222 on timeline 216. This may lead to uncertainty in a prediction of the lead time of the order of FIG. 2B. Lead times with this type of uncertainty may be referred to as “stochastic.” The uncertainty in a stochastic lead time may be caused by one or more uncertainty factors, such as, for example, uncertainty in a delivery time between the stages, manufacturing uncertainty, uncertainty upstream along the supply chain, or other uncertainty factors.

In some embodiments of the invention, inventory at a stage in a supply chain (e.g. supply chain 110) may be quantified in terms of a base stock parameter. In some instances, the base stock may include the inventory on hand plus the inventory that is currently on order, but has not yet arrived, minus any backorders. Additionally, the inventory at the stage in the supply chain may be quantified in terms of a safety stock parameter. In some embodiments, the safety stock may include the expected inventory on hand just prior to the arrival of an order.

In some embodiments of the invention, demand, both consumer demand and demand between stages 112, 114, 116, and 118, is uncertain or “stochastic”. The supply chain 110 may not know what consumer demand (or one or more of its parameters) will be in the future, and, consequently, future demand between stages 112, 114, 116, and 118 may be similarly unpredictable. Based on historical data various predictions with respect to a probability distribution and one or more statistical parameters that substantially describe the demand may be made. This stochastic demand may be further broken into two types. These two types of demand may include stationary demand and non-stationary demand. Stationary demand may include demand sufficiently described by underlying characteristics that may not change substantially with time. In other words, while the actual demand experienced may fluctuate randomly somewhat over time, the underlying probability distribution and its parameters may remain the same. Non-stationary demand may include demand substantially described by underlying characteristics that vary over time. For example, the mean and/or variance of the demand distribution may shift due to changes in the season of the year, the phase of the product lifecycle, or the point in the review cycle of a downstream stage.

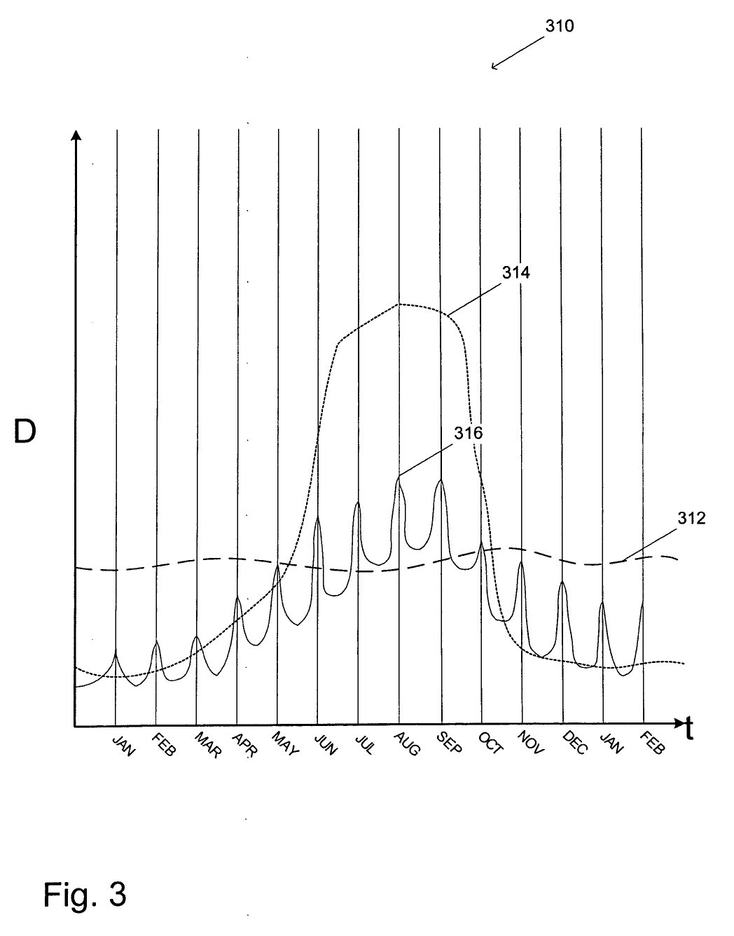

FIG. 3 illustrates a graphical representation 310 of demand, according to some embodiments of the invention. Graphical representation 310 includes a horizontal time axis and a vertical demand axis. Graphical representation 310 includes a first demand curve 312, a second demand curve 314, and a third demand curve 316, all of which represent forecasted or expected consumer demand with respect to different goods. First demand curve 312, is illustrated as a substantially flat horizontal line, with relatively little change in value over the time period shown. Consequently, first demand curve 312 might be modeled as stationary demand with a single mean and variance across the entire year.

In the embodiment illustrated by FIG. 3, the forecasts for both the second demand curve 314 and third demand curve 316 vary significantly over the time period depicted by graphical representation 310. Therefore, second demand curve 314 and third demand curve 316 may be classified as non-stationary demand. As can be appreciated from FIG. 3, second demand curve 314 may represent demand that fluctuates seasonally. In particular, second demand curve 314 peaks during the summer and early fall. In one embodiment, second demand curve 314 may represent consumer demand for a product used in backyard barbeques, such as barbeque sauce, or other goods typically used in higher quantities when the weather is warm. Since the demand represented by second demand curve 314 may follow a more or less predictable pattern each year, the demand may be referred to as cyclic non-stationary demand. According to yet another embodiment of the invention, third demand curve 316 represents demand that may be cyclic with respect to the time of year, and may also change in a more or less predictable manner based on the time of month. In one embodiment, third demand curve 316 may represent consumer demand for goods associated with an activity that becomes generally more prevalent in the warmer months, and spikes at the beginning/end of the month, such as, for example, moving, among other activities. For instance, third demand curve 316 may represent consumer demand for packing tape, or other goods associated with moving, or another similarly cyclical activity. It should be appreciated that non-stationary consumer demand, such as the demand represented by second demand curve 314 and/or third demand curve 316, may complicate inventory management for retailer stage 118 as retailer stage 118 seeks to keep inventory as low as practicable while still being able to sufficiently meet the fluctuating consumer demand. Additionally, these complications may be passed upstream to stages 116, 114, and 112 in supply chain 110 due to the relationship between the flow of goods along supply chain 110 and consumer demand that has been outlined above.

In some embodiments of the invention, when demand is stationary, such as the demand represented by first demand curve 312, a single value for mean and a single value for variance may adequately represent consumer demand, independent of the time period for which the demand is being described. In contrast, if second demand curve 314 were to be represented as a single mean value and a single variance value, independent of the time period for which the demand was being described, the actual demand at a particular point within the time period may not be sufficiently close to the mean value with a sufficiently high likelihood to enable calculations for the purposes of inventory control. Therefore, in order to describe non-stationary demand, such as, for example, the demand represented by second demand curve 314 and/or the demand represented by third demand curve 316, time may be broken into a set of time phases over which demand is relatively stationary. These time phases may be periodic, or may be selected to mirror predicted cyclical changes in consumer demand. For example, to describe the demand represented by second demand curve 314, each period of a year may be broken into a set of time phases. In one embodiment, the set of time phases may include one time phase from May-October and another time phase from November-April. The time phase from May-October may include a season of relatively high demand and the time phase from November-April may include a season of relatively lower demand. Third demand curve 316 may also be represented using these same time phases. Alternatively, the representation of third demand curve 316 may be enhanced by implementing time phases that are periodic and smaller. For example, since third demand curve 316 includes a monthly cycle, as well as a yearly cycle, time phases that divide each month into low and high periods may be implemented to enable third demand curve 316 to be sufficiently represented.

It should be appreciated that unless consumer demand for goods is perfectly stationary, the implementations of time phases may provide additional precision in representing demand, and that the smaller the windows of time used as time phases, the more precise the representation of demand may become. However, it may further be appreciated that implementing more and smaller time phases may introduce other complications to inventory modeling and/or planning, such as increased complexity, increased computational costs, or other complications. Therefore, decisions, automated and/or manual, on the implementation of time phases to adequately describe non-stationary demand may include a balance between accuracy and practicality.

In some embodiments of the invention, some or all of stages 112, 114, 116, and 118 may individually divide time into a plurality of review periods. Stages 112, 114, 116, and/or 118 may then review their respective inventories and trigger replenishments at fixed intervals of time called review periods. Actions on a review period may include recording the inventory, reviewing orders that were placed for goods from the stage, reviewing orders that were filled by the stage during the review period, and/or other activities, ultimately for the purpose of placing one or more orders for more goods. Review periods at different stages in a supply chain may be of different durations without restriction and may be anchored to different starting points on the calendar.

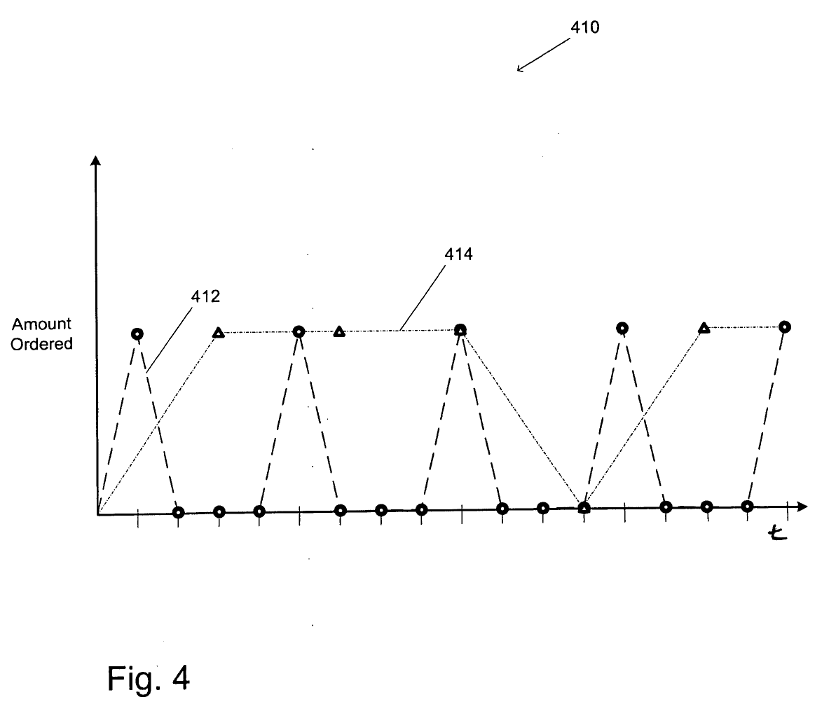

According to various embodiments of the invention, the implementation of review periods may introduce non-stationary demand into supply chain 110, even in instances in which consumer demand is substantially stationary. For example, FIG. 4 includes a graphical representation 410 of orders placed for goods between stages of a supply chain that includes a first plot 412 and a second plot 414. More specifically, graphical representation 410 includes a graph of an expected amount of goods ordered by one stage from another stage (i.e., demand between the stages) vs. time. The demarcations along the time axis may demarcate time periods of equal length (e.g. 1 week). In one embodiment, graphical representation 410 may include a graph of an amount of the manufactured goods ordered between stages in an example in which the consumer demand for the manufactured good is substantially stationary. In the set of circumstances illustrated by graphical representation 410, retailer stage 118 may implement a review period of four weeks. Therefore, retailer stage 118 may place an order with the same mean and standard deviation every four weeks (e.g. week 1, week 5, week 9, week 13, week 17, etc.) to meet the stationary consumer demand.

In one embodiment of the invention, plot 412 represents a plot of orders received by distributor stage 116 from retailer stage 118 for the manufactured goods. As can be appreciated from FIG. 4, the review period implemented by retailer stage 118 may result in peaks and valleys in demand between stages 116 and 118, with peaks every fourth week, even though the consumer demand experienced by retailer stage 118 may be substantially stationary. To further illustrate this phenomenon, plot 414 represents a plot of an amount of the manufactured goods ordered from manufacturer stage 114 by distributor stage 116, in an embodiment where distributor stage 116 implements review periods of 3 weeks and retailer stage 118 again implements review periods of 4 weeks, as in the embodiment described above. As with the embodiment depicted by plot 412, the difference between the review periods implemented by stages 116 and 118 in the embodiment depicted by plot 414 may cause the demand of distributor stage 116 for the manufactured good to appear to be non-stationary to manufacturer stage 114, even though retailer stage 118 may consider the demand to be stationary.

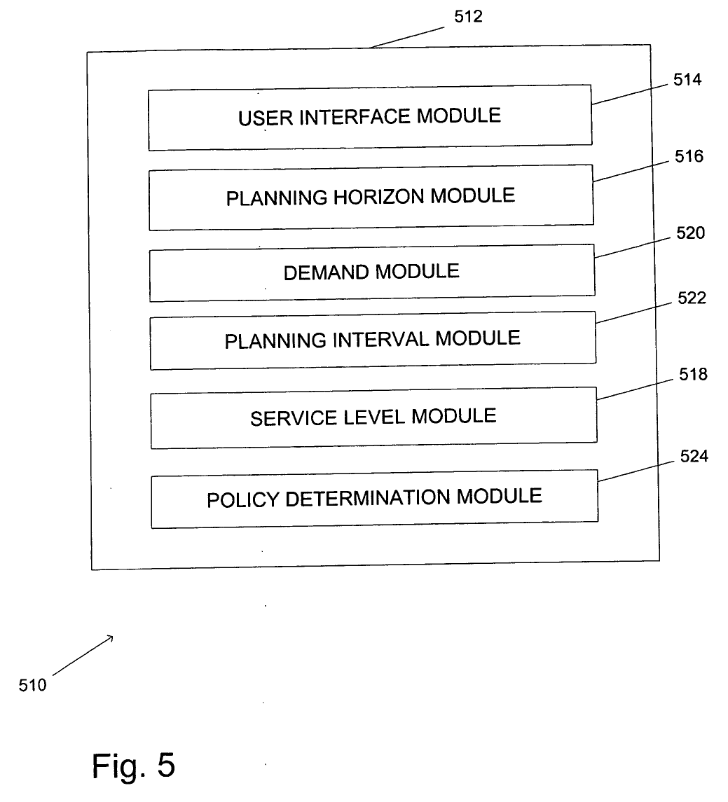

FIG. 5 is an exemplary illustration of a system 510 for determining a constant stock policy, in accordance with some embodiments of the invention. System 510 may include a processor 512 that may include a user interface module 514, a planning horizon module 516, a service level module 518, a demand module 520, a planning interval module 522, and a policy determination module 524. It should be appreciated that processor 512 may include one or more actual processor units that may be operatively linked for communication therebetween, and that, in embodiments including a plurality of processor units, the processor units may be located locally in a central location, or the processor units may be located remotely from each other. Additionally the processor units may be in direct communication with each other, or some or all of the processor units may be connected with others of the processing units via one or more networks, or via other operative communications links. In some embodiments, modules 514, 516, 518, 520, 522, and 524 may be implemented as software, hardware, firmware, or as some combination of software, hardware, and/or firmware. According to various embodiments of the invention, the modules 514, 516, 518, 520, 522, and 524 may leverage a mathematical inventory model to perform the various functionalities described herein. For example, the mathematical inventory model may include the mathematical inventory model leveraged by the inventory software suite entitled PowerChain® 4.5, developed and released by Optiant, Inc.

In some embodiments of the invention, user interface module 514 may enable a user to interact with system 510. User interface module 514 may enable the user to input, access, modify, organize, or otherwise manipulate information within system 510. Via user interface module 514, information may be conveyed to the user. For example, interface module 514 may include a Graphical User Interface (“GUI”) implemented on a computer. Other embodiments of user interface module 514 exist.

According to various embodiments of the invention, planning horizon module 516 may enable a planning horizon to be defined. Defining a planning horizon may include defining a period of time for which an inventory stock policy may be set. In some embodiments, defining a planning horizon may include receiving input from a user (e.g., via user interface module 514) regarding the period of time for which the user desires an inventory stock policy to be set. In one embodiment, a planning horizon may be specified by the user as a start date and an end date. In another embodiment, a planning horizon may be specified as a start date or an end date and a period of time over which the planning horizon may span. For example, the user may specify a number of base time periods (e.g., days, weeks, etc.) for the planning horizon.

In some embodiments of the invention, service level module 518 may enable a service level to be determined. A service level may represent a prediction of an ability of a stage within a supply chain (e.g., supply chain 110) to meet demand out of goods held in inventory over a future period of time. In some instances, a service level may include a probability that demand will be met by inventory over a particular period of time. This type of service level representation may not account for how much demand is missed when the stage is stocked out of a good within the time period, but instead, whether demand is high or low, simply represents that demand may be (or was) missed. In other instances, a service level may include a prediction of a percent of demand met from inventory over a period of time. This type of service level representation may take into account an amount of demand that may be missed while the stage is stocked out of the good.

In some embodiments of the invention, a service level may include an aggregate service level. The aggregate service level may be an aggregation of individual service levels taken for planning intervals (e.g. base time periods, time phases, review periods, etc.) that falls within a planning horizon. The individual service levels may be aggregated by averaging. In one embodiment, the individual service levels include the type of service level that is expressed as a probability that demand will be met by inventory over each planning interval within the planning horizon. In such an embodiment, the aggregate service level may include a weighted average of the individual service levels where the individual service levels may each be individually weighted according to a predicted demand during the planning interval to which they correspond.

According to various embodiments of the invention, demand module 520 may enable a prediction of demand over a future period of time, such as a planning horizon or other period of time. Demand module 520 may predict future demand by propagating demand predictions for consumer demand up the supply chain to stages 116, 114, and 112, taking into account each stage's ordering behavior. Turning briefly to FIG. 3, in some embodiments, demand module 520 may propagate a demand curve, such as second demand curve 314 or another demand curve, over a future time period to determine future demand at upstream stages.

Returning to FIG. 5, planning interval module 522 may enable a future time period, such as a planning horizon or other time period, to be divided into planning intervals such as base time periods, time phases, and/or review periods. Base time periods may include time periods of a periodic interval that may be used within the system to delineate time as a base unit of time (e.g., a day, 2 days, a week, 2 weeks, a month, etc.). In some instances, the period of the base time periods may be a configurable system parameter, or may be an automatically determined default. As was discussed above, time phases may be implemented to break time down based on predicted future demand. In some embodiments, planning interval module 522 may determine time phases over a planning horizon by automatically analyzing future demand that is non-stationary, and dividing the planning horizon into time phases in which demand in each of the time phases is sufficiently stationary. In other embodiments, a user may manually break a planning horizon into time phases by entering input into system 510 at user interface module 514. For example, the user may specify periodic time phases, and may even provide a period for the time phases. Alternatively, the user may enter time phases that are not periodic, but correspond substantially with fluctuations in future demand. As was set forth previously, review periods may be implemented to divide time into periods that correspond to periodic inventory reviews by a stage in a supply chain (e.g., supply chain 110). Planning interval module 522 may enable a planning horizon to be divided into review periods by receiving input from a user that may be input to system 510 at user interface module 514.

In some embodiments of the invention, policy determination module 524 may determine a constant stock policy for a stage in a supply chain (e.g., supply chain 110) for implementation over a planning horizon. The constant stock policy may be determined based on one or more of the planning horizon, a target service level, a predicted future demand, a delineation of time, and/or other factors. In some embodiments, policy determination module 524 may implement a mathematical inventory model to determine the constant stock policy. For example, policy determination module 524 may include a look-up table of constant stock policies previously determined based on the mathematical inventory model. Alternatively, policy determination module 524 may calculate the constant stock policy from a function based on the mathematical inventory model. In some instances, the constant stock policy may include a constant base stock policy, which may enable the stage to order up to a constant base stock at each review period. In other instances, the constant stock policy may include a constant safety stock policy, which may enable the stage to place orders so as to maintain a constant safety stock in inventory over the planning horizon.

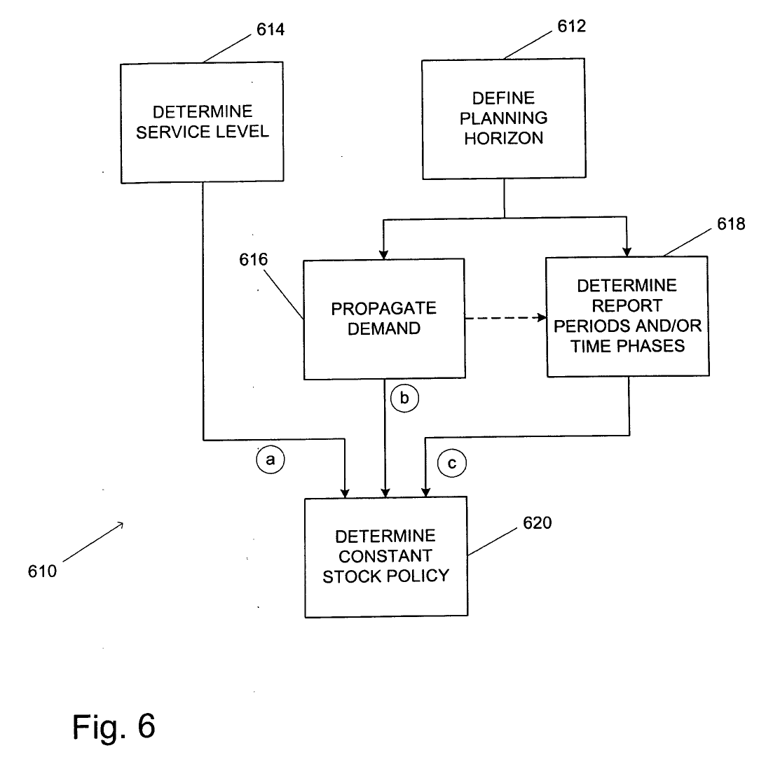

FIG. 6 illustrates an exemplary flowchart of a method 610 of determining a constant stock policy for a stage in a supply chain, according to some of the embodiments of the invention. At an operation 612, a planning horizon may be defined. In some embodiments, operation 612 may be executed by planning horizon module 516 in the manner described above. At an operation 614, a target service level may be determined. In some embodiments, operation 614 may be executed by service level module 518, as was previously set forth. At an operation 616, demand for the planning horizon may be determined. In some embodiments, operation 616 may be executed by demand module 520, as was described previously. For example, demand module 520 may propagate consumer demand through the planning horizon. At an operation 618, the planning horizon may be broken into time phases and/or review periods. In some embodiments, operation 618 maybe executed by planning interval module 522 in the manner set forth above. At an operation 620, the constant stock policy for the planning horizon may be determined. In some embodiments, operation 620 may be executed by policy determination module 524, as was previously described.

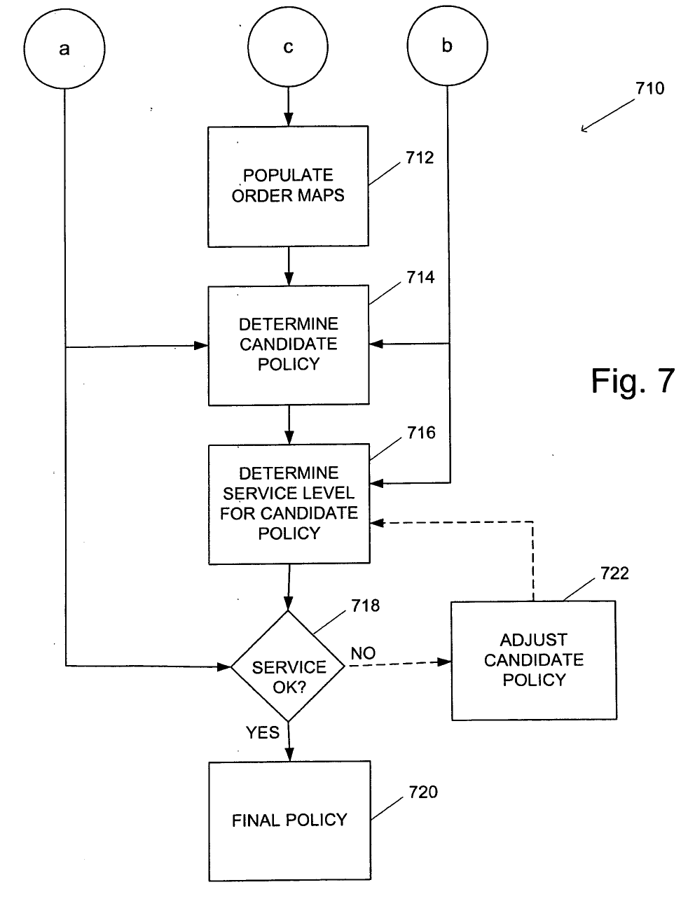

FIG. 7 is an exemplary flow map of a method 710 of determining a constant stock policy. In some embodiments of the invention, method 710 may be performed at operation 620 of method 610 (shown in FIG. 6). As inputs, method 710 may implement outputs a, b, and c from operations 614, 616, and 618, as illustrated in FIG. 6. Based on the determination of review periods and time phases within a planning horizon, an order map for each time phase may be populated at an operation 712 of method 710. The population of order maps may depend on one or more arrival windows of the determined time phases. An arrival window of a time phase may include periods of time when orders placed within the time phase (e.g. at review periods) are predicted to arrive. The arrival window of the time phase may be determined independent of whether the order includes a deterministic lead time or a stochastic lead time. To calculate a constant base stock policy, an order map for a time phase within the planning horizon may include any previous time phases whose arrival windows intersect the time phase. This may be in part because an order placed in one phase per the constant base stock of that phase may arrive in another phase. To calculate a constant safety stock policy, an order map for a time phase within the planning window may include any previous time phases whose arrival windows end within the time phase. This may be in part because an order placed per the constant safety stock target of one time phase may arrive in a phase preceding the former phase.

At an operation 714, a candidate stock policy may be determined. The candidate stock policy may be determined by implementing an algorithm to provide a constant stock policy that will meet a target service level (input a) over the arrival windows of the time phases of the planning horizon. The target service level may be interpreted as a desired aggregate service level that may be expressed as a weighted average of the probability that demand will be met over the planning horizon, where the average is weighted according to demand present (input b) at a given time. The candidate stock policy may be determined through the implementation of an algorithm that leverages a mathematical inventory model. In one embodiment, the mathematical inventory model may yield a function that can be solved for the candidate stock policy. In another embodiment, the mathematical inventory model may be implemented to establish a look-up table, and the candidate stock policy may be determined based on the look-up table.

In some embodiments of the invention, the delineation of time used to determine the candidate stock policy may include the arrival windows of the time phases, and not the time phases themselves. The service level achieved by the candidate stock policy over the arrival windows of the time phases may vary from the service level achieved over the actual time phases. Consequently, at an operation 716 the service level achieved by the candidate stock policy over the actual time phases of the planning horizon may be determined. As with the determination of the candidate stock policy, the service level achieved by the candidate stock policy over the actual time phases may be determined by implementing an algorithm based on the mathematical inventory model.

At an operation 718, the service level achieved by the candidate stock policy over the actual time phases may be compared to the target service level. If the service level achieved by the candidate stock policy is sufficiently comparable to the target service level, then the candidate stock policy may be adopted as the constant stock policy for implementation at an operation 720. In some embodiments, operation 720 may include providing the constant stock policy to a user (e.g., via user interface module 514). However, if the service level achieved by the candidate stock policy is not sufficiently comparable to the target service level, the candidate stock policy may be adjusted at an operation 722. A service level achieved by the adjusted candidate stock policy may be determined, and that service level may be compared to the target service level at operations 716 and 718, respectively. It may be appreciated that operations 718, 722, and 716 form an iterative loop that may operate to bring the service level provided by the candidate stock policy into a predetermined relationship with the target service level. For example, method 710 may only proceed from operation 718 to operation 720 when the service level calculated at operation 716 is greater than or equal to the target service level. Alternatively, method 710 may only proceed from operation 718 to operation 720 when the service level calculated at operation 716 deviates from the target service level by less than a predetermined amount.

It should be appreciated that although the various embodiments of the invention set forth above have been described with respect to a supply chain along which goods flow, that this is not intended to be limiting and that the scope of the invention may encompass flows of labor, money, equipment, land, information, services, and/or other commodities or resources.

It can thus be appreciated that embodiments of the present invention have now been fully and effectively accomplished. The foregoing embodiments have been provided to illustrate the structural and functional principles of the present invention, and are not intended to be limiting. To the contrary, the present invention is intended to encompass all modifications, alterations and substitutions within the spirit and scope of the appended claims.

What is claimed is:

1. A method of determining an inventory stock policy for stocking goods at a stage within a supply chain, the method comprising:
determining a target service level;
defining a planning horizon;
predicting demand for the good over the planning horizon, wherein the predicted demand is non-stationary;
determining a constant stock policy that provides a service level over the planning horizon in a predetermined relationship with the target service level, wherein the constant stock policy remains constant over the planning horizon.

2. The method of claim 1, wherein the constant stock policy is a constant base stock policy.

3. The method of claim 1, wherein the constant stock policy is a safety stock policy.

4. The method of claim 1, further comprising dividing the planning horizon into planning intervals, wherein the service level provided by the constant stock policy over the planning horizon is determined by aggregating service levels provided by the constant stock policy within the planning intervals.

5. The method of claim 4, wherein the service levels provided by the constant stock policy within the planning intervals are aggregated by determining a weighted average of the service levels.

6. The method of claim 5, wherein the service levels provided by the constant stock policy within the planning intervals are weighted for determining the weighted average according to the predicted demand for the good within the planning intervals.

7. The method of claim 1, wherein the constant stock policy is determined by implementing a mathematical inventory model.

8. The method of claim 1, wherein the planning intervals comprise time phases, the time phases being determined such that the demand for the goods within the individual time phases is substantially stationary.

9. The method of claim 1, wherein the planning intervals comprise review periods during which an inventory of the goods at the stage is reviewed.

10. The method of claim 8, wherein the planning intervals comprise review periods during which an inventory of the goods at the stage is reviewed.

11. The method of claim 1, wherein the planning intervals are periodic.

12. The method of claim 1, wherein the planning intervals comprise base time periods.

13. The method of claim 1, wherein the service level provided over the planning horizon is greater than or equal to the target service level.

14. The method of claim 1, wherein the service level provided over the planning horizon is sufficiently close to the target service level.

15. A system for determining an inventory stock policy for stocking goods at a stage within a supply chain, the method comprising:
a service level module that determines a target service level;
a planning horizon module that define a planning horizon;
a demand module that predicts demand for the good over the planning horizon, wherein the predicted demand is non-stationary;
a policy determination module that determines a constant stock policy that provides a service level over the planning horizon in a predetermined relationship with the target service level, wherein the constant stock policy remains constant over the planning horizon.

16. The system of claim 15, wherein the constant stock policy is a constant base stock policy.

17. The system of claim 15, wherein the constant stock policy is a safety stock policy.

18. The system of claim 15, further comprising a planning interval module that divides the planning horizon up into planning intervals, wherein the service level provided by the constant stock policy over the planning horizon is determined by aggregating service levels provided by the constant stock policy within the planning intervals.

19. The system of claim 18, wherein the service levels provided by the constant stock policy within the planning intervals are aggregated by determining a weighted average of the service levels.

20. The system of claim 19, wherein the service levels provided by the constant stock policy within the planning intervals are weighted for determining the weighted average according to the predicted demand for the good within the planning intervals.

21. The system of claim 15, wherein the policy determination module implements a mathematical inventory model.

22. The system of claim 15, wherein the planning intervals comprise time phases, the time phases being determined such that the demand for the goods within the individual time phases is substantially stationary.

23. The system of claim 15, wherein the planning intervals comprise review periods during which an inventory of the goods at the stage is reviewed.

24. The system of claim 22, wherein the planning intervals comprise review periods during which an inventory of the goods at the stage is reviewed.

25. The system of claim 15, wherein the planning intervals are periodic.

26. The system of claim 15, wherein the planning intervals comprise a base time period.

27. The system of claim 15, wherein the service level provided over the planning horizon is greater than or equal to the target service level.

28. The system of claim 15, wherein the service level provided over the planning horizon is sufficiently close to the target service level.
